(19) United States
(12) Patent Application Publication
(10) Pub. No.: US 2012/0189797 A1
(43) Pub. Date: Jul. 26, 2012

(54) Sample paint wall stickers

(76) Inventor: Elizabeth Nancy Moriba, London (GB)

(21) Appl. No.: 12/925,644

(22) Filed: Jan. 24, 2011

(51) Int. Cl. G09F 5/00; G09F 3/10; B32B 7/12

(52) U.S. Cl. 428/42.1; 428/42.3

(57) ABSTRACT

The present invention relates to wall stickers for paint samples. The invention is used by personnel in the area of property development such as builders, designers, interior decorators, painters, do-it-yourselfers, and the like. The paint sample stickers allow you to see how multiple colors or patterns look on your walls, without fully committing or having to paint over a paint sample numerous times once decided. This paint sample is also used with wall paper designs in the decision making process, when considering redecorating one's home. The stickers will provide a visualization of color combinations on painted walls, wallpapers, kitchen work surfaces, cupboard textures and shades. The paint sample sticker is particularly placed in a strip or book arrangement. The stickers are also available in single units. The used samples are reusable as wrapping paper, art paper, party hats, and the like.

The present invention relates to wall stickers for paint samples. The invention provides a simple easy stick on and peel off paint sample/wallpaper stickers. These novel stickers require relatively less packaging and hence replace visual color coded paper and paint pot samples. The sticker is a paper based product and hence can be recycled for re-use. The repositionable tape on the back of the sticker allows the user to move colors around from wall to wall, room to room without ever using a brush. The stickers provide clean walls after removal without leaving patches of samples to be removed later. The stickers are either presented as strips on a card, very similar to that of the current ‘hold up’ sample cards or customized into a ‘sticker book’ to suit individual consumer needs and desires. Individual stickers are also used to reflect the color combinations on painted walls, wallpapers, kitchen work surfaces, cupboard textures and the like.

### BACKGROUND OF THE INVENTION

This invention relates generally to the field of apparatus with the following purpose or function: Concept relates to a method and device for a paint sample wall sticker apparatus. Moreover it pertains specifically to such apparatus with the following general description: The present invention relates to wall stickers for paint samples. The invention is used by personnel in the area of property development such as builders, designers, interior decorators, painters, do-it-yourselfers, and the like. The paint sample stickers allow you to see how multiple colors or patterns look on your walls without fully committing or having to paint over a paint sample numerous times once decided. This paint sample is also used with wall paper designs in the decision making process, when considering redecorating one's home. The stickers will provide a visualization of color combinations on painted walls, wallpapers, kitchen work surfaces, cupboard textures and shades. The paint sample sticker is particularly placed in a strip or book arrangement. The stickers are also available in single units. The used samples are reusable as wrapping paper, art paper, party hats, and the like.

### SUMMARY OF THE INVENTION

In view of the limitations now present in the prior art, the present invention provides a new and useful method, which is simpler in construction, more universally usable and more versatile in operation than known apparatus of this kind.

The purpose of the present invention is to provide new and novel features not extrapolated in prior art; hence resulting in a new concept which is not apparent, obvious, or suggested, either directly or indirectly by any of the prior art apparatus.

Purpose or Function: Concept relates to a method and device for a paint sample wall sticker apparatus.

Physical Description: The present invention relates to wall stickers for paint samples. The invention provides a simple easy stick on and peel off paint sample/wallpaper stickers. These novel stickers require relatively less packaging and hence replace visual color coded paper and paint pot samples. The sticker is a paper based product and hence can be recycled for re-use. The repositionable tape on the back of the sticker allows the user to move colors around from wall to wall, room to room without ever using a brush. The stickers provide clean walls after removal without leaving patches of samples to be removed later. The stickers are either presented as strips on a card, very similar to that of the current ‘hold up’ sample cards or customized into a ‘sticker book’ to suit individual consumer needs and desires. Individual stickers are also used to reflect the color combinations on painted walls, wallpapers, kitchen work surfaces, cupboard textures and the like.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to overcome the deficiencies of prior art devices.

An object of the present invention: relates to a method and device for a paint sample wall sticker apparatus that: Provides a method and device for a paint or texture sample wall sticker system that requires less packaging than present inventions.

Another object of the present invention: relates to a method and device for a paint sample wall sticker apparatus that: Provides a method and device for a paint or texture sample wall sticker system that is more cost effective than present inventions.

Another object of the present invention: relates to a method and device for a paint sample wall sticker apparatus that: Provides a method and device for a paint or texture sample wall sticker system that is more eco-friendly than present inventions.

Another object of the present invention: relates to a method and device for a paint sample wall sticker apparatus that: Provides a method and device for a paint or texture sample wall sticker system that requires less clean-up than present inventions.

Another object of the present invention: relates to a method and device for a paint sample wall sticker apparatus that: Provides a method and device for a paint or texture sample wall sticker system that is easier to use than present inventions.

Another object of the present invention: Concept relates to a method and device for a paint sample wall sticker apparatus. that is more universally functional in today's market than the prior art devices.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention.

FIG. 1. is a perspective view of the present invention: Sample faint Wall Stickers

### DETAILED DESCRIPTION OF THE INVENTION

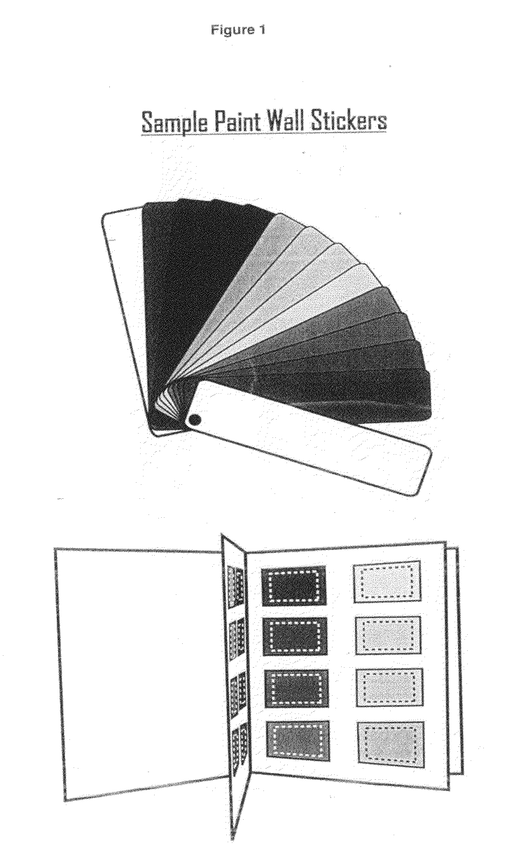

Referring now descriptively to the drawings, the attached figures illustrate a Sample Paint Wall Stickers. FIG. 1 illustrates: Sample Paint Wall Stickers according to the present invention:

The present invention relates to wall stickers for paint samples. The invention is used by personnel in the area of property development such as builders, designers, interior decorators, painters, do-it-yourselfers, and the like. The paint sample stickers allow you to see how multiple colors or patterns look on your walls without fully committing or having to paint over a paint sample numerous times once decided. This paint sample is also used with wall paper designs in the decision making process, when considering redecorating one's home. The stickers will provide a visualization of color combinations on painted walls, wallpapers, kitchen work surfaces, cupboard textures and shades: The paint sample sticker is particularly placed in a strip or book arrangement. The stickers are also available in single units. The used samples are reusable as wrapping paper, art paper, party hats, and the like.

The present invention relates to wall stickers for paint samples. The invention provides a simple easy stick on and peel off paint sample/wallpaper stickers. These novel stickers require relatively less packaging and hence replace visual color coded paper and paint pot samples. The sticker is a paper based product and hence can be recycled for re-use. The repositionable tape on the back of the sticker allows the user to move colors around from wall to wall, room to room without ever using a brush. The stickers provide clean walls after removal without leaving patches of samples to be removed later. The stickers are either presented as strips on a card, very similar to that of the current ‘hold up’ sample cards or customized into a ‘sticker book’ to suit individual consumer needs and desires. Individual stickers are also used to reflect the color combinations on painted walls, wallpapers, kitchen work surfaces, cupboard textures and the like.

1. This sample paint wall sticker is paper based.

2. The sample paint wall sticker can be presented in different sizes.

3. Individual stickers can be presented on a card, very similar to that of the current ‘hold up’ sample colour cards.

4. The sample paint wall sticker will stick to the wall or any flat hard surface to enable visualisation of paint sample from varied distances.

5. This paint sample wall sticker will be flat and smooth once on the required surface, to allow proper visual contrast between surface and paint sample.

6. A reusable, pressure sensitive adhesive will be used to enable easy peel from the base card and from the surface on which the sample paint wall sticker is placed for distance visualisation.

7. The sample paint wall sticker will have light releasable ‘grab’ bond with anything it comes into contact with. This will enable the user to peel the sample paint wall sticker off the surfaces with ease without leaving any paper or glue residue on the wall or surface.

8. One sample paint wall sticker can be used multiple times and can be easily repositioned on the surface.

9. The paint sample wall sticker can also be used with other textures other than paint. For example; wall paper designs.
